(19) United States
(12) Patent Application Publication
(10) Pub. No.: US 2011/0032239 A1
(43) Pub. Date: Feb. 10, 2011

(54) Electronic Picture Frame

(75) Inventor: Deaji Lou, Guangdong (CN)

Correspondence Address: DONGGUAN TAIYO OPTRONICS CO., LTD, BAISHIGANG MANAGEMENT DISTRICT, CHANGPING TOWN DONGGUAN, GUANGDONG, 523559, omitted

(73) Assignee: DONGGUAN TAIYO OPTRONICS CO., LTD, GUANGDONG (CN)

(21) Appl. No.: 12/988,323

(22) PCT Filed: Mar. 31, 2009
(86) PCT No.: PCT/CN2009/071105

§ 371 Date: Oct. 17, 2010

(30) Foreign Application Priority Data
Dec. 18, 2008 (CN) 200810220139.1

(51) Int. Cl. G09G 3/36; G06F 3/038

(52) U.S. Cl. 345/211; 345/87

(57) ABSTRACT

The present invention discloses an electronic photo frame, comprising a main frame body, a LCD, and circuit components, wherein, the LCD is arranged on the main frame body; the present invention further comprises a secondary frame body hinged to the main frame body; a transparent plate is arranged on the secondary frame body, and a photo containing cavity is arranged between the transparent plate and the secondary frame body; the circuit components are arranged in the main frame body or secondary frame body; thus the secondary frame body can receive conventional paper photos, while the main frame body displays digital photos. Compared to existing products, the present invention can meet two demands with a single photo frame; therefore, the practicability is greatly improved.

### BACKGROUND OF THE INVENTION

The present invention relates to a home digital appliance, in particular to an electronic photo frame.

An electronic photo frame is a digital apparatus specially designed to view and share digital photos. It can decodes digital image files in storage media and display the images on a LCD. It can display multiple photos simultaneously and display different photos cyclically. An existing electronic photo frame usually comprises a LCD that displays digital images, a frame body that accommodates the LCD, and circuit components arranged on the frame body. Such an electronic photo frame can only display digital photos, but can't receive or display conventional photos. The function of such an electronic photo frame is too simple, and the practicability should be further improved.

### BRIEF SUMMARY OF THE INVENTION

The object of the present invention is to provide an electronic photo frame that can display both digital photos and conventional photos.

The present invention solves the technical problem with the following technical scheme: an electronic photo frame, comprising a main frame body, a LCD, and circuit components, wherein, the LCD is arranged on the main frame body; the electronic photo frame further comprises a secondary frame body hinged to the main frame body; a transparent plate is arranged on the secondary frame body, and a photo containing cavity is arranged between the transparent plate and the secondary frame body.

The circuit components are arranged in the main frame body. Or, the circuit components are arranged in the secondary frame body.

The circuit components comprise a main control chip, a storage media, I/O components, and a Li-ion cell.

The beneficial efficacies of the present invention lie in: a secondary frame body is hinged to the main frame body, a transparent plate is arranged on the secondary frame body, and a photo containing cavity is arranged between the transparent plate and the secondary frame body to contain conventional paper photos, while the main frame body can display digital photos. Compared to existing products, the present invention can meet two demands with a single photo frame; therefore, the practicability is greatly improved.

### BRIEF DESCRIPTION OF THE DRAWINGS

Hereunder the present invention will be further detailed in the embodiments, with reference to the accompanying drawings.

FIG. 1 is a structural diagram of the present invention;

FIG. 2 is a structural diagram of the circuit components in the present invention.

### DETAILED DESCRIPTION OF THE INVENTION

Hereunder the present invention will be further detailed, with reference to the accompanying drawings.

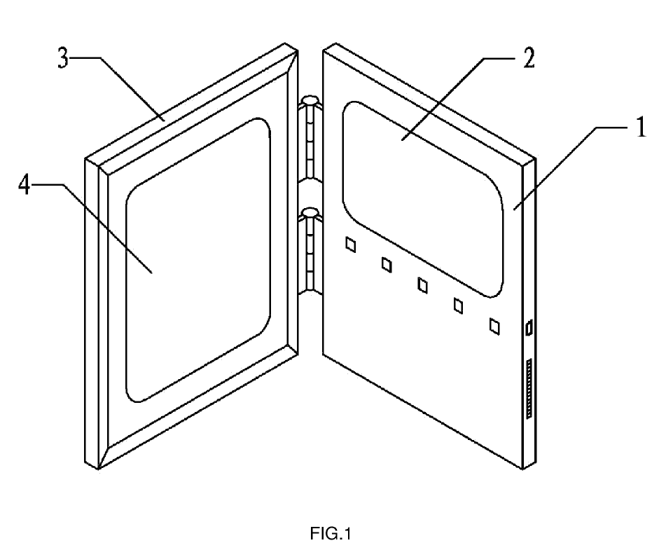

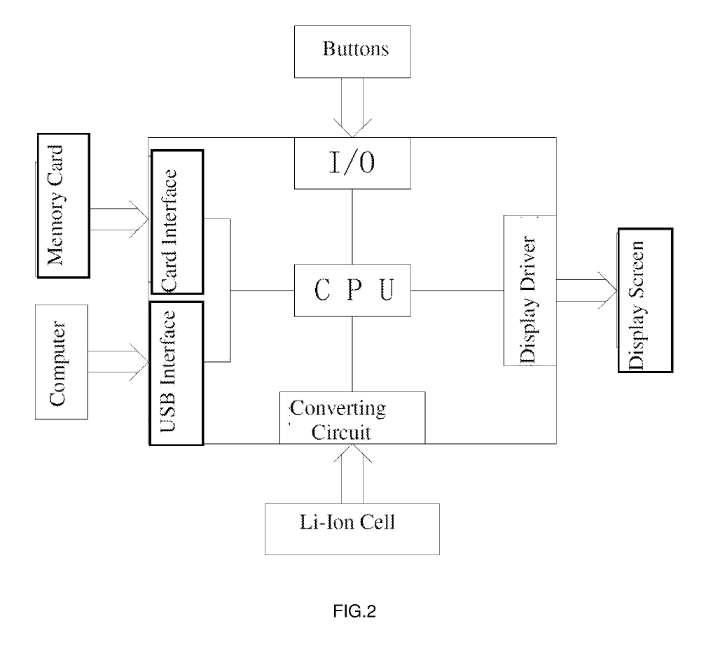

As shown in FIG. 1 and FIG. 2, the present invention provides an electronic photo frame, comprising a LCD 2 designed to display digital images of digital photos, a main frame body 1 that accommodates the LCD 2, and circuit components, wherein, the circuit components comprise a main control chip, a storage media, I/O components, and a Li-ion cell, wherein, the main control chip comprises: a decoding module that decodes the digital images, an image zooming module that zooms in/out the decoded image data, an encoding module that encodes the zoomed image data so as to store the data in the storage media; the LCD 2 is arranged on the main frame body 1, a secondary frame body 3 is hinged to the main frame body 1, a transparent plate 4 is arranged on the secondary frame body 3, and photo containing cavity is arranged between the transparent plate 4 and the secondary frame body 3, so that the secondary frame body 3 can receive conventional paper photos, while the main frame body 1 can display digital photos. Compared to existing products, the present invention can meet two demands with a single frame, and therefore the practicability is greatly improved.

As a specific embodiment, the circuit components are arranged in the main frame body 1, below the LCD 2; a storage media interface and an USB interface are arranged in sequence on a side wall of the main frame body 1, wherein, the storage media interface can receive SD card, MMC card, MS card, or XD card, and supports plug-and-play; once a storage media that stores digital photos is inserted into the storage media interface, the corresponding images will be displayed on the LCD; the USB interface can be connected directly to a computer to transmit digital photo data; operating buttons are arranged below the LCD 2. Such an arrangement provides a neat and elegant front layout of the electronic photo frame, and fully meets the user's visual requirement.

As another embodiment of the present invention, the circuit components are arranged in the secondary frame body 3, and the storage media interface and USB interface are arranged on a side wall of the secondary frame body 3, so that the entire space in the main frame body 1 can be used to accommodate the LCD 2; on one hand, the size of the LCD can be maximized, and thereby the displayed digital photos can be maximized; on the other hand, the thickness of the main frame body 1 can be minimized, to meet the consumer's requirement for low-profile electronic photo frame.

While the principle and efficacies of the present invention are described and illustrated in above embodiments, the present invention is not limited to these. It is noted that those skilled in the art can make variations and modifications without departing from the spirit of the present invention; however, such variations and modifications shall be deemed as falling into the protected domain of the present invention.

What is claimed is:

1. An electronic photo frame, comprising a main frame body (1), a LCD (2), and circuit components, wherein, said LCD (2) is arranged on the main frame body (1); wherein, the electronic photo frame further comprises a secondary frame body (3) hinged to the main frame body (1), a transparent plate is arranged on the secondary frame body (3), and a photo containing cavity is arranged between the transparent plate (4) and the secondary frame body (3).

2. The electronic photo frame according to claim 1, wherein, the circuit components are arranged in the main frame body (1).

3. The electronic photo frame according to claim 1, wherein, the circuit components are arranged in the secondary frame body (3).

4. The electronic photo frame according to claim 1, 2, or 3, wherein, the circuit components comprise a main control chip, a storage media, I/O components, and a Li-ion cell.
